(19) United States
(12) Patent Application Publication
(10) Pub. No.: US 2002/0174114 A1
(43) Pub. Date: Nov. 21, 2002

(54) Method for searching for contents of a computer network

(75) Inventor: Bernd Eisinger, Stockern (AU)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/140,264

(22) Filed: May 8, 2002

(30) Foreign Application Priority Data
May 16, 2001 (DE) 101 23 773.1

(51) Int. Cl. G06F 17/30

(52) U.S. Cl. 707/3; 707/10

(57) ABSTRACT

The invention concerns a method for operating a computer (1) of a computer network (2), in which a user (5) enters a search criterion of a search for contents (11) of the computer network (2), the search is performed and the contents (11) found within the scope of the search are output to the user (5). In order to render output of the contents (11) of the computer network (2) as user-specific as possible, it is proposed that a user profile assigned to the user (5) be called up which is dependent on search criteria (7) employed by the user (5) in previous searches; the found contents (11) be output in consideration of the user profile, and the search criterion (7) of the current search be automatically used to update the user profile.

### BACKGROUND OF THE INVENTION

The inventions is based on a priority application DE 101 23 773.1 which is hereby incorporated by reference.

The present invention concerns a method for operating a computer of a computer network. According to the method, a user enters a search criterion of a search for contents of the computer network. The search is performed and the contents found within the scope of the search are output to the user.

The invention additionally concerns a method for searching for contents of a computer network on the basis of a search criterion entered by a user. According to the method, the search is performed and the contents found within the scope of the search are output to the user via the computer.

Finally, the present invention also concerns a computer of a computer network which serves to perform a search for contents of the computer network on the basis of a search criterion entered by a user and to output the contents found within the scope of the search.

Known from the prior art is the Internet, which is a global computer network. The Internet comprises a multiplicity of computers which are designed as Internet servers and on which are stored a multiplicity of different contents. The contents are, for example, information, offers, computer programs and audio or video data. For the purpose of selectively finding specific contents, from the multiplicity of contents, so-called search engines are used according to the prior art. Known search engines are, for example, Altavista (http://www.altavista.com), Yahoo (http://yahoo.com), Excite (http://www.excite.de) or Google (http://www.google.com).

To search for contents on the Internet, a user delivers a certain search criterion to a search engine. The search engine searches a large part of the Internet for the searched contents, sorts the found contents into a given sequence and then outputs the sorted contents to the user. The individual search engines differ in, amongst other things, their search strategy, i.e., how the Internet is searched and which contents are considered in the search, and in the sequence in which the found contents are output. Whereas, in the case of Altavista or Yahoo, the number of hits and the source of the hits (whether in the heading or in the body of the text of a document) are decisive criteria for the sequence, in the case of Google the sequence is determined primarily by the number of references to the found content (Internet page) from other contents (Internet pages).

Likewise, in the area of offering and marketing of goods or services (so-called electronic commerce, or e-commerce), searching of the Internet or various Internet pages of the provider is performed on the basis of a search criterion entered by the user and the found goods or services are displayed in a certain sequence. In the case of a search with a conventional search engine, the sequence of the displayed goods or services depends on the output criteria of the respective search engine. In the case of a search for goods or services within the Internet pages of a particular provider, the sequence of the output goods or services is determined on the basis of provider-specific output criteria.

Thus, in the case of both the known search engines and the known e-commerce applications, output of the found contents is not user-specific. Consequently, it can happen that contents are frequently output at the start of the output sequence which are only of little interest to the user, whereas the contents which are of particular relevance to the user are output only further back in the sequence, or are not output at all.

So-called data mining represents a first step in the direction of user-specific output of found contents in e-commerce applications. In the case of data mining, the purchasing behavior of a user is analyzed and a purchasing profile, assigned to the user, is compiled from this. However, the purchasing profile compiled through data mining is generally limited to directly modifying or updating the purchasing profile from the purchasing habits of the user. If the user persistently selects special offers, for example, this is evaluated as an indication of his/her interest in low-cost goods or services. This is noted in the purchasing profile, and the searched goods or services are then displayed to the user in a sequence from cheaper goods or services to more expensive goods or services. To summarize, it can be stated that data mining analyzes only behavior of a user that is consciously, rather than subconsciously, controlled by him/her. The purchasing behavior of a user is evaluated with the objective of influencing his/her future purchasing behavior. There is thus a direct relationship between the evaluated information and the nature and sequence of the output contents.

The object of the present invention is to be able to output contents of a computer network in a more user-specific manner.

### SUMMARY OF THE INVENTION

To achieve this objective, the invention, proceeding from the method for operating a computer of a computer network of the type initially stated, proposes that

a user profile assigned to the user be called up, the user profile being dependent on the search criteria employed by the user in previous searches;

the found contents be output in consideration of the user profile;

the search criterion of the current search be automatically used to update the user profile.

According to the present invention, therefore, it is not simply the purchasing behavior of a user that is used for determining a purchasing profile. Rather, the behavior of the user in accessing the contents of the computer network, the so-called surfing behavior of the user, is used for determining the user profile. Rather than storing merely the purchasing behavior of the user that is limited to e-commerce applications, the user profile stores, quite generally, the behavior of the user in the computer network, e.g. the requested contents and the dwell time on certain contents. By means of appropriate cross-links and cross-references between the individual behavioral characteristics of the user, criteria can then be determined, from the general surfing behavior of the user, for the output of any contents of the computer network.

The method according to the invention enables the user profile to be determined in a substantially more detailed and more reliable manner. This, in turn, permits a user-specific output of information of a type and in a sequence that are highly relevant to the user. In particular, the present invention enables the area of electronic offering and marketing via the Internet (e-commerce) to be designed in a substantially more efficient manner, since the user is presented first with those offers which are also of actual interest to him/her.

The entry of a search criterion also includes the entry of an Internet protocol (IP) address of a particular Internet page via a so-called browser. In this case, the contents to be output are determined, not by a search engine, but through direct selection of the corresponding Internet page. The entry of a search criterion also includes the selection of further Internet pages, via cross-links (so-called hyperlinks) from a first Internet page to the further Internet pages. Since the surfing behavior of a user is characterized by the search criteria, entered by the user, of a computer-network-wide search for certain contents of the computer network, a particularly reliable user profile can be compiled on the basis of the search criteria of the user.

According to an advantageous development of the present invention, it is proposed that the user profile be updated in dependence on contents of the computer network which are selected by the user. In addition to the search criteria entered by the user, other, further aspects of his/her surfing behavior can be taken into account, such as, for example, the question of which contents of the computer network are selected by the user and how long he/she dwells on the various contents. The question of the nature of the selected contents can be answered in any level of detail. The more precisely the selected contents are analyzed, the greater the level of detail with which the user profile can be compiled. Thus, for example, a particularly accurate profile of a user can be compiled if it is not only known that, on average, the user views current news for a certain period of time, but if it is also known that during this period the user primarily views business news.

According to a preferred embodiment of the present invention, it is proposed that, of the found contents, only selected contents be output, the contents to be output being selected in dependence on the user profile. It is furthermore proposed that the found contents be output in a sequence which is determined in dependence on the user profile. Thus, in particular, the nature and the sequence of the contents to be output are set in a user-specific manner by means of the user profile.

According to another advantageous development of the present invention, it is proposed that the search for contents of the computer network be effected, via the computer, from an access portal to the computer network. An access portal is, for example, a particular Internet start page which contains offers and cross-references (hyperlinks) to further Internet pages. The user enters a password at the start, for the purpose of identification. Alternatively, the user can also be identified on the basis of an automatically transmitted identifier (telephone number of the caller in the case of ISDN, so-called CLIP function). Subordinate to the access portal, an appropriate facility is provided for analyzing the surfing habits of the user and, in particular, for analyzing the search criteria entered by the user. The facility is designed as, for example, a computer program. The selection of a particular offer or a particular reference to other contents from the access portal is used by the analysis program to update the user profile. The computer program also analyzes information on the contents of the computer network that are selected by the user and the dwell time on the contents.

The user profile advantageously comprises several behavioral characteristics, each of which characterizes a certain behavior of the user. A behavioral characteristic is, for example, the price consciousness of the user. The price consciousness of the user can again be divided into different goods or services, or into groups of goods or services. Thus, for example, it would be conceivable for a user to exhibit a strong price consciousness with respect to foodstuffs, but very little price consciousness with respect to clothing, i.e., to be highly brand conscious.

According to a preferred embodiment, the search criterion of the current search is used directly to update at least one behavioral characteristic of the user profile. Thus, for example, the price consciousness of the user can be deduced directly from goods or services purchased. The price consciousness can be divided, for example, into “low price”, “special offers”, “good quality at moderate prices” or “brand consciousness”.

Alternatively, or additionally, at least one further behavioral characteristic of the user profile can be used to update at least one behavioral characteristic of the user profile. Thus, according to this embodiment, the behavioral characteristics are interlinked by cross-links or cross-references and are mutually influencing. Thus, the social behavior of the user can be determined, for example, on the basis of the behavioral characteristics “price-related interests” and “financial news interests”, amongst others.

As a further means of achieving the object of the present invention, it is proposed, proceeding from the method for searching for contents of a computer network of the type initially stated, that

a user profile assigned to the user be called up, the user profile being dependent on the search criteria employed by the user in previous searches;

the found contents be output in consideration of the user profile; and

the search criterion of the current search be automatically used to update the user profile.

As a further, additional, means of achieving the object of the present invention, it is proposed, proceeding from the computer of a computer network of the type initially stated, that the computer have

access to a user profile, assigned to the user, which is dependent on the search criteria employed by the user in previous searches;

means for outputting the found contents in consideration of the user profile; and

means for automatically updating the user profile in dependence on the search criterion of the current search.

### BRIEF DESCRIPTION OF THE DRAWINGS

Further features, application possibilities and advantages of the invention are disclosed by the following description of embodiment examples of the invention, which are represented in the drawing. All described or represented features, either in themselves or in any combination, constitute the subject matter of the invention, irrespective of how they are combined in the claims or how they are related, and irrespective of how they are worded and represented in, respectively, the description and drawing, wherein:

FIG. 1 shows a flow diagram of a method according to the invention for operating a computer of a computer network; and

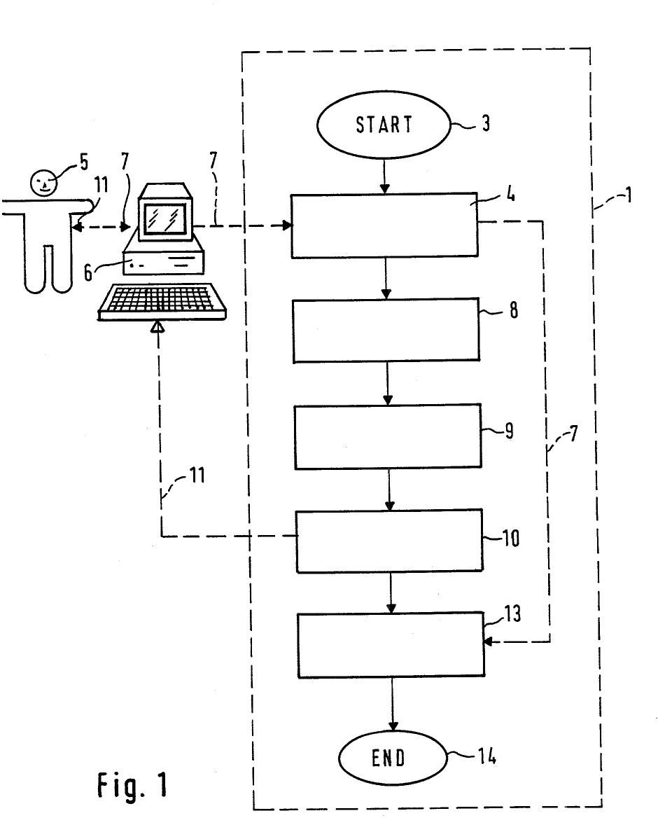

FIG. 2 shows a computer network with a computer according to the invention.

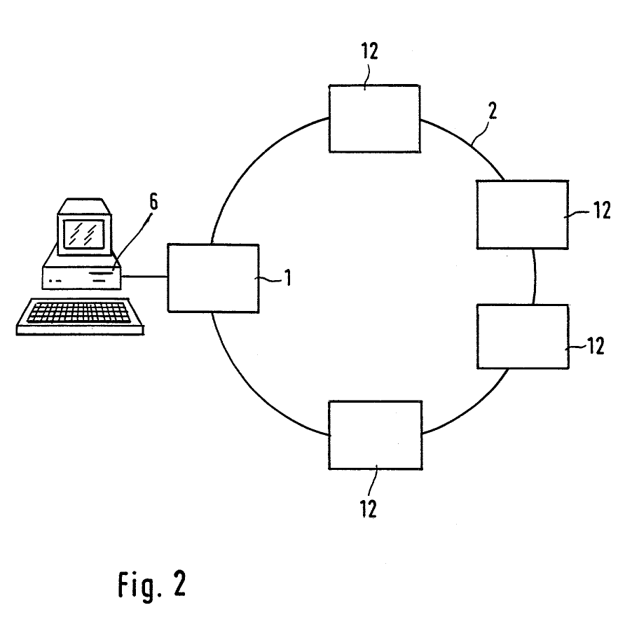

The method according to the invention is executed on a computer 1 of a computer network 2, or of the Internet. The method according to the invention serves to operate the computer 1 with the objective of improving the search for contents of the computer network 2. The method according to the invention starts in a function block 3. Search criteria 7 for the search are entered by a user 5, via a computer 6, in a function block 4. The desired search is then performed in a function block 8. If, for example, the user searches for Internet pages with a certain content, the search can be performed from the function block 8, for example, by means of a conventional search engine. It is also conceivable, however, for a conventional IP (Internet protocol) address of an Internet page to be entered in the function block 4 and for the search from the function block 8 to comprise only the call-up of the desired Internet page.

According to the invention, there is called up in a function block 9 a user profile which is dependent on the search criteria 7 which were employed by the user 5 in previous searches. The user profile comprises several behavioral characteristics, each of which characterizes a certain behavior of the user. Behavioral characteristics used are not only characteristics which are subject to direct external influence such as, for example, the purchasing behavior of the user, but also such characteristics which are not subject to direct external influence such as, for example, the social behavior of the user 5. The behavioral characteristics are again divided into four categories. Thus, for example, the behavioral characteristic “price consciousness” is divided into the categories “low prices”, “special offers”, “good quality at moderate price” and “brand consciousness”. Likewise, the behavioral characteristic “social behavior”, for example, is divided into the categories “price-related interests”, “interests in financial news”, etc.

In a function block 10 of the method according to the invention, the contents found within the scope of the search performed in the function block 8 are output in consideration of the user profile called up in the function block 9. For the purpose of outputting the contents 11, they can either be displayed on a monitor screen of the computer 6, printed out on a printer connected to the computer 6 or output by other means. It is conceivable that, for the purpose of outputting the contents 11, they can be stored on data media (for example, on diskettes) or transmitted, via the computer network 2, to other computers 12 of the computer network, where they are then stored. Of the found contents, only selected contents 11 are output, the contents 11 to be output being selected in dependence on the user profile. Likewise, the found contents 11 can be output in a particular sequence which is determined in dependence on the user profile.

The user profile is updated, in a function block 13, on the basis of the search criteria 7 of the current search. For this purpose, the search criteria 7 of the current search can be used directly to update at least one behavioral characteristic of the user profile. Likewise, at least one behavioral characteristic of the user profile can be updated on the basis of at least one further behavioral characteristic. This means that the individual behavioral characteristics of the user profile can be linked to one another and be mutually influencing. New behavioral characteristics can also be generated within the scope of the updating of the user profile, so that a comprehensive and detailed representation of the user 5, or of his/her characteristics, results over time. The method according to the invention is ended in the function block 14.

For reasons of data protection, it should be ensured that a user profile does not become available to unauthorized persons. The user profile should be used only by persons or companies to whom or to which the user 5 has given his/her express consent. The user profile should be stored in such a way that it can be accessed and inspected by the user 5 at all times, but not inspected by other users of the computer network 2. The user 5 should have the possibility of subsequently withdrawing his/her consent to use of the user profile, i.e., of being able to disable the entire user profile or individual behavioral characteristics of the user profile. The user profile, or individual behavioral characteristics, should then be erased and no further updating of the user profile should be performed.

For the purpose of updating the user profile, a profile parameter, corresponding to one or more behavioral characteristics, is assigned to the contents of the computer network 2. Electronic milestones are distributed over the individual contents. If a milestone is exceeded, for example, in the context of the use of an application of the computer network 2, the category of the corresponding behavioral characteristic is raised or lowered by a predefinable value.

The user-specific output of the contents 11 can be achieved in that there is assigned to the contents of the computer network 2, i.e., information, offers, etc., additional information, in the form of profile information, which defines the user target groups for which the special information or offers are of particular significance. Particular categories of behavioral characteristics of a user profile can be assigned, as profile information, to the information or offers. The contents 11 whose behavioral characteristics are closest to, and preferably correspond to, the behavioral characteristics of the user, are then output.

1. Method for operating a computer of a computer network, in which a user enters a search criterion of a search for contents of the computer network, the search is performed and the contents found within the scope of the search are output to the user, wherein
a user profile assigned to the user is called up, the user profile being dependent on the search criteria employed by the user in previous searches;
the found contents are output in consideration of the user profile; and
the search criterion of the current search is automatically used to update the user profile.

2. Method according to claim 1, wherein the user profile is updated in dependence on contents of the computer network which are selected by the user.

3. Method according to claim 1, wherein of the found contents, only selected contents are output, the contents to be output being selected in dependence on the user profile.

4. Method according to claim 1, wherein the found contents are output in a sequence which is determined in dependence on the user profile.

5. Method according to claim 1, wherein the search for contents of the computer network is effected, via the computer, from an access portal to the computer network.

6. Method according to claim 1, wherein the user profile comprises several behavioral characteristics, each of which characterizes a certain behavior of the user.

7. Method according to claim 6, wherein the search criterion of the current search is used directly to update at least one behavioral characteristic of the user profile.

8. Method according to claim 6, wherein at least one further behavioral characteristic of the user profile is used to update at least one behavioral characteristic of the user profile.

9. Method for searching for contents of a computer network on the basis of a search criterion entered by a user, in which the search is performed and the contents found within the scope of the search are output to the user, wherein
a user profile assigned to the user is called up, the user profile being dependent on the search criteria employed by the user in previous searches;
the found contents are output in consideration of the user profile; and
the search criterion of the current search is automatically used to update the user profile.

10. Computer of a computer network, for performing a search for contents of the computer network on the basis of a search criterion entered by the user and for outputting contents found within the scope of the search, wherein the computer has
access to a user profile, assigned to the user, which is dependent on search criteria employed by the user in previous searches;
means for outputting the found contents in consideration of the user profile; and
means for automatically updating the user profile in dependence on the search criterion of the current search.
